(19) United States
(12) Patent Application Publication
(10) Pub. No.: US 2025/0033520 A1
(43) Pub. Date: Jan. 30, 2025

(54) SYSTEM AND METHOD FOR RECHARGING ELECTRIC VEHICLES

(71) Applicant: Yen Jung Sung, New York, NY (US)

(72) Inventor: Yen Jung Sung, New York, NY (US)

(21) Appl. No.: 18/789,662

(22) Filed: Jul. 30, 2024

Related U.S. Application Data
(60) Provisional application No. 63/529,757, filed on Jul. 30, 2023.

(51) Int. Cl. B60L 53/80; B60L 53/18; B60L 53/53; B60L 53/65; B60L 53/66; B60L 53/68

(52) U.S. Cl. CPC B60L 53/80; B60L 53/18; B60L 53/53; B60L 53/65; B60L 53/665; B60L 53/68

(57) ABSTRACT

A battery distribution hub includes a cabinet with a plurality of batteries therein that may be removed, such as via a lift, and disposed within the trunk of a vehicle. A suitable charging cable for the battery is also provided, that electrically interfaces the battery with the battery charging system in the vehicle. The trunk of the vehicle includes an internal electrical port into which the charging cable can be plugged to electrically connect the battery disposed in the trunk of the vehicle with the vehicle battery charging electronics.

### CROSS-REFERENCE TO RELATED APPLICATIONS

This application claims the benefit of U.S. provisional application No. 63/529,757, filed Jul. 30, 2023, the contents of which are incorporated by reference herein.

### BACKGROUND OF THE INVENTION

### 1. Field of the Invention

The present invention generally relates to the recharging of electric vehicles. In particular, the present invention relates to methods and related systems for providing electric vehicle recharging services using batteries that can charge the electric vehicle at a parked location of the vehicle.

### 2. Description of the Related Art

Electric vehicles are growing increasingly common, replacing vehicles powered by internal combustion engines. Nonetheless, the electric vehicle charging infrastructure is much less developed than the refueling infrastructure for internal combustion engine vehicles. As a result, a common concern amongst owners of electric vehicles is the idea of “range anxiety,” in which vehicle owners worry that there may be insufficient or even no charging stations en route to a destination. Further, even if such stations exist, they may be fully occupied by other electric vehicles or, in some cases, internal combustion vehicles that park at such stations mistakenly or to antagonize.

There therefore exists a need for improved methods and related systems for charging electric vehicles.

### BRIEF DESCRIPTION OF THE DRAWINGS

The various aspects and embodiments disclosed herein will be better understood when read in conjunction with the appended drawings, wherein like reference numerals refer to like components. For the purposes of illustrating aspects of the present application, there are shown in the drawings certain preferred embodiments. It should be understood, however, that the application is not limited to the precise arrangement, structures, features, embodiments, aspects, and devices shown, and the arrangements, structures, features, embodiments, aspects and devices shown may be used singularly or in combination with other arrangements, structures, features, embodiments, aspects and devices. The drawings are not necessarily drawn to scale and are not in any way intended to limit the scope of this invention, but are merely presented to clarify illustrated embodiments of the invention. In these drawings:

FIG. 1 is a block diagram of an embodiment environment for providing electric vehicle recharging services.

FIG. 2 is a block diagram of an embodiment battery cabinet.

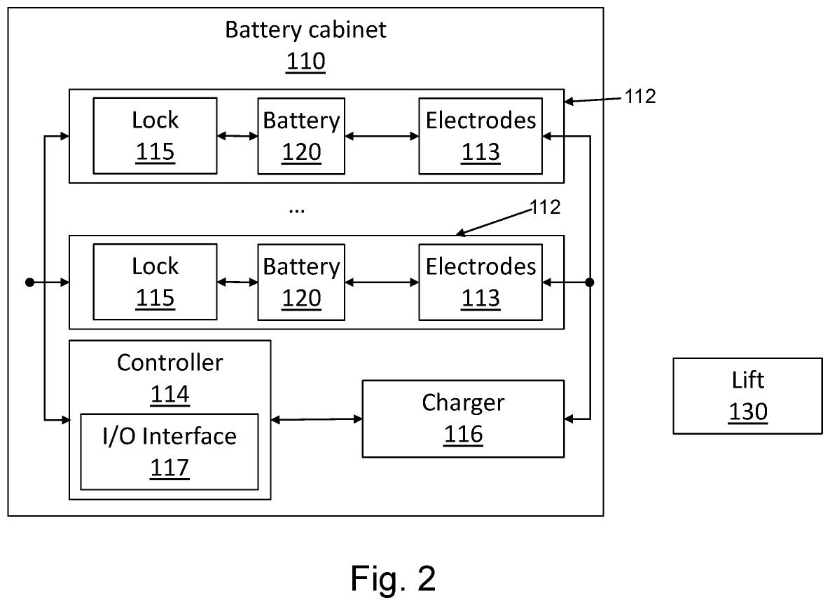

FIG. 3 is a back view of an electric vehicle.

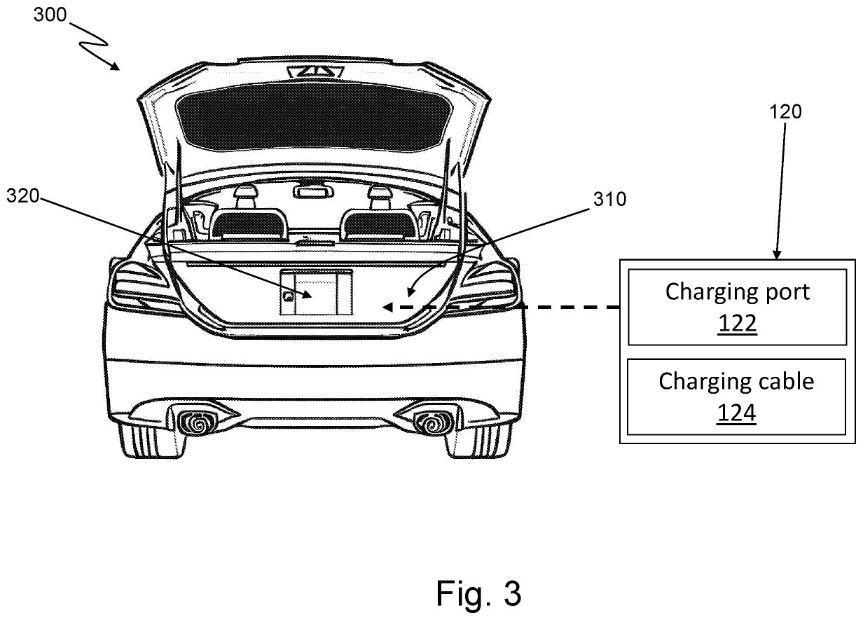

### DETAILED DESCRIPTION OF THE PREFERRED EMBODIMENTS

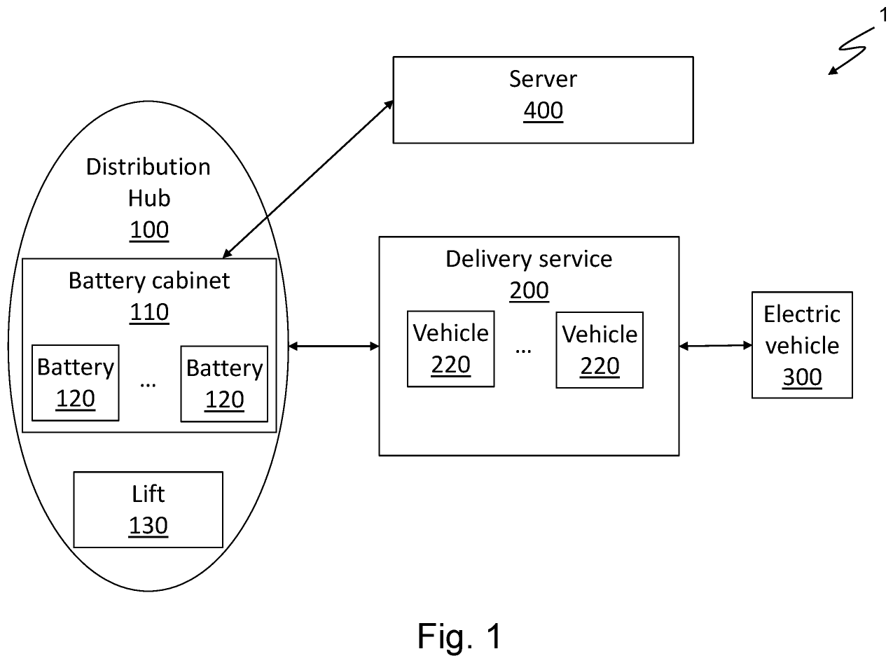

With reference to FIG. 1, in one embodiment a system for recharging an electric vehicle 300 includes a distribution hub 100 and a delivery service 200. A plurality of batteries 120 are removably stored in a batter cabinet 110 of distribution hub 100. Electric vehicle 300 may visit distribution hub 100 directly to obtain a battery 120 therefrom or return a battery 120 thereto, optionally using lift 130 supplied at distribution hub 100 for this purpose. Alternatively, a user of vehicle 300 may employ delivery service 200 to deliver a battery 120 directly to the current location of vehicle 30. Delivery vehicles 220 of delivery service 200 obtain batteries 120 from distribution hub 100 for delivery to vehicles 300 and may also return batteries 120 obtained from vehicles 300 to distribution hub 100.

Battery cabinet 110 includes a plurality of slots 112 configured to receive a respective battery 120. Battery cabinet 110 further includes an electronic controller 114 that controls operations of battery cabinet 110 and a charger 116 electrically coupled to controller 114 used to charge batteries 120. Controller 114 may include a processor, memory, and instructions stored in the memory and executable by the processor to perform various operations as set forth herein. Charger 116 may include any suitable battery charging circuit or circuits, as know in the art, to charge each battery 120 in its respective slot 112, and the functionality of charger 116 may be controlled by controller 114, such as to selectively turn on or turn off charging for any battery 120 within its respective slot 112. Charger 116 may also provide charging information to controller 114, such as the charge state of each battery 120, the amount of electrical energy spent charging a battery 120, the identification number of a battery 120 within its respective slot 112, the perceived health of a battery 120, etc. Controller 114 may use this information for logging purposes (e.g., for customer billing, troubleshooting, etc.) and to control operations of cabinet 110.

Each slot 112 includes electrodes 113 that are configured to electrically couple to corresponding electrodes on battery 120 when battery 120 is received in its slot 112. Electrodes 113 are electrically coupled to charger 116 so as to electrically connect each battery 120 to charger 116 for charging and status monitoring purposes.

Each slot 112 also includes a respective lock 115. Each lock 115 is configured to mechanically engage the battery 120 when it is disposed in its slot 112. Controller 114 can respectively control each lock 115 to release or engage its respective battery 120. When engaged, lock 115 prevents its respective battery 120 from being removed from slot 112. When lock 115 is disengaged, as instructed by controller 114, a user at cabinet 110 may remove battery 120 from its slot 112, optionally using lift 130 to do so. Similarly, when a battery 120 is placed into a slot 112, lock 115 preferably automatically engages with battery 120 to prevent it from thereafter being removed from slot 112.

Controller 114 preferably includes an input/output (I/O) interface 117, coupled to the processor in controller 114, that is used to both interface with users and, optionally, networking equipment. Interface 117 may include, for example, a credit card reader, a wireless networking interface, or the like. Interface 117 may also be connected via wired or wireless interfaces to a wide area network, such as the internet, to communicate with one or more servers 400 under the control of charging system 1. Interface 117 may permit controller 114 to communicate with another wireless device, such as a cellphone or the like, of a user to enable the user to obtain a battery from cabinet 110, or to return a battery to cabinet 110. Alternatively, such as by use of a credit card, a user may obtain or return a battery 120. Server 400 may be used to remotely control operations of cabinet 110 and to keep track of usage data, users, account information, billing information, cabinet 110 health data, battery 120 health, and the like. For example, server 400 may track the state of each battery 120 via information received from controller 114, such as whether that battery 120 has been loaned out to a vehicle 300 (including a unique identifier of battery 120 and the identification of a related user for billing purposes), whether a loaned-out battery 120 (via its unique identifier) has been returned to a slot 122 (and, for example, the unique identifier of slot 112 into which battery 120 was placed), the charge status of each battery 120, etc. With such user and battery information, server 400 may determine how much to bill each user of vehicle 300, determine whether or not to dispense a battery 120 to a user of vehicle 300 (such as based on payment and/or battery return information), determine if a battery 120 is failing and needs to be replaced, etc. Server 400 can accept information from a user, such as user identification, payment information, user or vehicle 300 location, and vehicle 300 type and model to determine the type and location of a battery 120 and charging cable 124 to cause to be dispensed from cabinet 110 or delivered to vehicle 300 via delivery vehicle 220. Server 400 thus may provide a user interface as known in the art to allow users to interface with server 400 and provide vehicle 300 information to server 400 that can be used for the dispensing and dispatching of batteries 120 and charging cables 124 to vehicles 300.

Each battery 120 is preferably configured to mechanically mate with lift 130, using any suitable mechanical means, so that a user may employ lift 130 to remove a battery 120 from, or insert a battery 120 into, a slot 112. Hence, lift 130 may include a mechanical interface that complements a corresponding mechanical interface on each battery 120 to enable lift 130 to mechanically engage and grapple a battery 120 to move such battery 120 to another location, or into or out of a slot 112. Lift 130 may be electrically powered to remove, lift, and lower a battery 120. Lift 130 may also be transversely movable, such as by wheels, tracks, or the like, so that lift 130 can be moved towards or away from cabinet 110 and towards or away from a vehicle 300. Lift 130 may be physically coupled to cabinet 110 to prevent lift 130 from being stolen, misused or the like.

Vehicle 300 includes a trunk 310, which may be in the front or rear of vehicle 300, as known in the art. At least one of batteries 120 in distribution hub 100 is sized to fit within trunk 310. A electrical port 320 is preferably disposed within trunk 310, although it may be disposed anywhere inside vehicle 300, and is electrically coupled to the battery charging system of electric vehicle 300. Battery 120 may include a charging port 122 and a charging cable 124, an end of which can be plugged into charging port 122 and another end of which can be plugged into electrical port 320 of electric vehicle 300. Charging cable 124 may be fixed to battery 120, or removably attached to battery 120. Charging cable 124 thus has an end that is mechanically and electrically compatible with electrical port 320 of vehicle 300. Charging cable 124 is sized so that it may extend from battery 120 to electrical port 320 when battery 120 is disposed within truck 310 or otherwise inside vehicle 300. Electrical port 320 is therefore preferably disposed at a location in vehicle 300 such that it is accessible by charging cable 124 when battery 120 is disposed within trunk 310. Distribution hub 100, such as cabinet 110, may include a plurality of charging cables 124 that may be dispensed with battery 120 based upon the type and electrical characteristics of vehicle 300, including electrical port 320 and/or required length of charging cable 124, which may be determined from information received from a user via I/O interface 117 or from server 400. Cabinet 120 may include a dispenser configured to selectively dispense a charging cable 124 in accordance with such electrical characteristic information. This cable dispenser may also be configured to accept a charging cable 124 from a user so that such cable 124 may be returned to the system with its corresponding battery 120. Alternatively, each charging cable 124 may be held in a slot 112 and dispensed with its corresponding battery 120 and similarly be returned via a slot 112. Hence, distribution hub 100 may be able to support a plurality of vehicle 300 types by way of charging cables 124. Each charging cable 124 may further include a DC-DC or DC-AC adapter to match the electrical and mechanical input characteristics of electrical port 320 of vehicle 300 with that of battery 120.

In operations, a user may, via a user device (e.g., cell phone, computer or the like) interface with I/O interface 117 of cabinet 100 to select both a battery 120 and a suitable charging cable 124 (such as by vehicle 300 make and model, or by other characteristics). Alternatively, the user may interface with server 400 to provide request information, such as via a web browser, cellphone application, or the like, which server 400 may use to control operations of cabinet 110. Using lift 130, the user may remove battery 120 from its slot 112 and dispose it into trunk 310 of vehicle 300. One end of charging cable 124 is then plugged into charging port 122 of battery 120, and the other end of charging cable 124 is plugged into electrical port 320 of vehicle 300. Because charging cable 124 includes electrical adaption circuitry, the power provided by charging cable 124 (from battery 120) matches the electrical characteristics for vehicle 300 charging port 320. The battery charging system internal to vehicle 300 then draws power from battery 120 inside truck 310 to recharge the battery internal and native to vehicle 300. Once battery 120 is depleted, it and its associated cable 124, may both be returned to distribution hub 100.

Alternatively, a delivery vehicle 220 of delivery service 200 may bring both a battery 120 and suitable charging cable 124 from distribution hub 100 and deliver it to the current location of user-vehicle 300, in accordance with user-suppled information of vehicle 300 received from server 400. Such user-supplied information may include, for example, the current location of vehicle 300, the make/model of vehicle 300, or any other suitable identifying characteristics to permit delivery of a suitable battery 120 and charging cable 124 to vehicle 300. Delivery vehicle 220 may also include a lift to place battery 120 into truck 310 and to remove a depleted battery 120 from trunk 310. Delivery vehicles 220 may include one or more cabinets with slots, analogous to cabinet 110, for transporting batteries 120. Used batteries 120 and their associated charging cables 124 may be returned to distribution hub 100 by a delivery vehicle 220. Delivery vehicle 220, or a user of delivery vehicle 220, may include identification that I/O interface 117 can read to identify delivery vehicle 220 to cabinet 110 and release of suitable battery 120 from its slot 112. Such identification could include any suitable device, such as an RFID card, a cellphone, a PIN number typed into a keyboard of I/O interface 117, a biometric scanner of I/O interface 117, etc.

In some embodiments, a vehicle 300 without a electrical port 320 may be modified to include charging port 320. Any suitable method known in the art may be employed to add electrical port 320 to vehicle 300.

Those skilled in the art will recognize that the present invention has many applications, may be implemented in various manners and, as such is not to be limited by the foregoing embodiments and examples. Any number of the features of the different embodiments described herein may be combined into one single embodiment, the locations of particular elements can be altered and alternate embodiments having fewer than or more than all of the features herein described are possible. Functionality may also be, in whole or in part, distributed among multiple components, in manners now known or to become known.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention. While there have been shown and described fundamental features of the invention as applied to being exemplary embodiments thereof, it will be understood that omissions and substitutions and changes in the form and details of the disclosed invention may be made by those skilled in the art without departing from the spirit of the invention. Moreover, the scope of the present invention covers conventionally known, future developed variations and modifications to the components described herein as would be understood by those skilled in the art.

What is claimed is:

1. A system for recharging an electric vehicle, the electric vehicle comprising an internal electrical port, the system comprising:
at least one battery cabinet, one of the battery cabinets comprising:
a plurality of slots configured to removably accept a plurality of batteries respectively, each slot comprising at least an electrode to electrically connect to one of the batteries;
the plurality of batteries configured to be removably received in the slots, each battery sized to fit inside the electric vehicle;
a plurality of charging cables, each charging cable configured to electrically connect to the internal electrical port inside the electric vehicle with one of the plurality of batteries;
a charger electrically coupled to the electrodes, the charger configured to selectively charge a battery in a respective slot via the at least an electrode of the slot;
a controller communicatively coupled to the charger, the controller configured to selectively cause the charger to charge one or more of the batteries in their respective slots;
a server communicatively coupled to the controller, the controller comprising an input/output interface configured to communicate with the server to transmit information concerning the batteries to the server and to accept commands from the server to control operations of the cabinet; and
at least a delivery vehicle configured to deliver one or more of the plurality of batteries to the electric vehicle;
wherein the server is configured to receive a request from at least one user and cause the delivery vehicle to dispatch at least one of the plurality of batteries to the electric vehicle according to the request.

2. The system of claim 1 wherein the input/output interface includes a reader to accept payment information from a user.

3. The system of claim 1, wherein each slot further comprises a lock for selectively locking the respective battery in the slot, and the controller is further configured to selectively disengage the locks from their respective batteries to dispense the batteries, each battery configured to mechanically engage with a lock in a respective slot.

4. The system of claim 3 wherein the cabinet is further configured to dispense one of the charging cables according to information received from the controller to conform to electrical and mechanical characteristics of the internal electrical port of the electric vehicle.

5. The system of claim 1, wherein the controller is further configured to unlock a battery from a slot and one of the plurality of charging cables according to the input/output interface receiving identification information corresponding to the service vehicle.

6. The system of claim 1 wherein at least one charging cable comprises a voltage converter configured to convert a voltage delivered from one of the batteries to a voltage suitable for the internal electrical port of the electric vehicle so that a battery connected to the charging cable is capable od charging a battery of the electric vehicle via the internal electrical port.

7. The system of claim 1 further comprising a lift for mechanically engaging the batteries to remove at least one of the batteries from its respective slot and dispose the battery into a trunk of the electric vehicle or into the delivery vehicle.

8. The system of claim 1 wherein the controller is configured to collect charging information from the charger and to transmit the charging information to the server.

9. The system of claim 1 where the plurality of charging cables are respectively configured to mechanically and electrically interface with internal electrical ports of a plurality of different electric vehicles.
